(19) United States
(12) Patent Application Publication
(10) Pub. No.: US 2010/0136319 A1
(43) Pub. Date: Jun. 3, 2010

(54) METHOD FOR FORMING MESOPOROUS SILICA LAYER, ITS POROUS COATING, ANTI-REFLECTION COATING, AND OPTICAL MEMBER

(75) Inventors: Hiroaki IMAI, Kanagawa (JP); Masato YAMAGUCHI, Tokyo (JP); Kazuhiro YAMADA, Saitama-ken (JP); Hiroyuki NAKAYAMA, Tokyo (JP)

Correspondence Address: GREENBLUM & BERNSTEIN, P.L.C., 1950 ROLAND CLARKE PLACE, RESTON, VA, 20191, US

(73) Assignees: KEIO UNIVERSITY, Tokyo (JP); HOYA CORPORATION, Tokyo (JP)

(21) Appl. No.: 12/610,530

(22) Filed: Nov. 2, 2009

(30) Foreign Application Priority Data
Dec. 3, 2008 (JP) 2008-308746

(51) Int. Cl. B32B 3/26; B05D 5/06; B05D 3/04; B05D 3/14

(52) U.S. Cl. 428/315.5; 427/162; 427/539

(57) ABSTRACT

A method for forming a mesoporous silica layer composed of nanometer-sized, mesoporous silica particles on an optical substrate or a dense layer formed thereon, comprising the steps of (1) hydrolyzing and polycondensing alkoxysilane in a solvent containing a catalyst, a cationic surfactant and a nonionic surfactant to prepare composites comprising nanometer-sized, mesoporous silica particles and these surfactants, (2) applying a solution containing the composites to the substrate or the dense layer, (3) drying the solution to remove the solvent, and (4) removing both surfactants by baking the resultant coating at 120-250° C. in an oxygen-containing gas atmosphere, or plasma-treating it using an oxygen-containing gas.

### FIELD OF THE INVENTION

The present invention relates to a method for forming a mesoporous silica layer having a low refractive index and excellent anti-reflection characteristics while removing surfactants at relatively low temperatures, a porous coating formed thereby, and an anti-reflection coating and an optical member comprising such porous coating.

### BACKGROUND OF THE INVENTION

Because mesoporous silica layers have high porosity and low refractive indices, their application to anti-reflection coatings on optical substrates such as lenses has been investigated. The mesoporous silica layer is conventionally formed by aging a solution comprising a silica-forming material such as tetraethoxysilane, a catalyst, a surfactant, an organic solvent and water, applying a solution containing the resultant organic-inorganic composites to a substrate, and drying and baking the resultant coating to remove organic components.

For instance, Hiroaki Imai, “Chemical Industries,” September, 2005, Vol. 56, No. 9, pp. 688-693, issued by Kagaku Kogyo-Sha. describes a method for forming a high-transmittance, mesoporous silica coating, which comprises aging a solution comprising tetraethoxysilane, a cationic surfactant (cetyl trimethyl ammonium chloride) and a nonionic surfactant [HO(C₂H₄O)₁₀₆—(C₃H₆O)₇₀—(C₂H₄O)₁₀₆H] under acidic conditions hydrochloric acid, adding ammonia water to prepare a solution containing nanometer-sized, mesoporous silica particles coated with the nonionic surfactant and having the cationic surfactant in pores, applying this solution to a substrate, drying the resultant coating, and baking it at 600° C. to remove the cationic surfactant and the nonionic surfactant. However, this method cannot be used for optical glass or plastic substrates having low glass transition temperatures because of high baking temperatures.

JP 2005-116830 A discloses a method for producing a porous silica coating with organic residues fully reduced, which comprises aging a solution comprising alkoxysilane, a surfactant, a catalyst and a solvent, applying a solution containing the resultant porous silica precursor to a substrate, and baking the resultant coating at a temperature of 260-450° C. in a moist atmosphere. However, because of baking at temperatures not sufficiently low, this method is likely to provide strain or poor appearance to optical glass or plastic substrates having low glass transition temperatures.

JP 2007-321092 A discloses a method for producing a porous silica coating with organic residues fully reduced, which comprises aging a solution comprising alkoxysilane, a surfactant, a catalyst and a solvent, applying a solution containing the resultant porous silica precursor to a substrate, baking the resultant coating at a temperature of 100-400° C., and irradiating the coating with ultraviolet rays. However, because of ultraviolet irradiation, the method of JP 2007-321092 A causes solarization on optical substrates, resulting in poor optical characteristics.

### OBJECT OF THE INVENTION

Accordingly, an object of the present invention is to provide a method for forming a mesoporous silica layer having a low refractive index and excellent anti-reflection characteristics while removing surfactants at relatively low temperatures, a porous coating formed by such method, and an anti-reflection coating and an optical member comprising such porous coating.

### DISCLOSURE OF THE INVENTION

As a result of intensive research in view of the above object, the inventors have found that a mesoporous silica layer having a low refractive index and excellent anti-reflection characteristics can be formed by conducting the hydrolysis and polycondensation of alkoxysilane in the presence of a catalyst, a cationic surfactant, a nonionic surfactant and a solvent, to prepare composites of nanometer-sized, mesoporous silica particles and these surfactants, drying a coating comprising the composites, and baking the coating at a temperature of 120-250° C. in an oxygen-containing gas atmosphere, or subjecting it to a plasma treatment using an oxygen-containing gas, to remove the surfactants at relatively low temperatures. The present invention has been completed based on such finding.

Thus, the first method of the present invention for forming a mesoporous silica layer composed of nanometer-sized, mesoporous silica particles on an optical substrate or a dense layer formed thereon, comprises the steps of (1) aging a solution comprising alkoxysilane, a catalyst, a cationic surfactant, a nonionic surfactant and a solvent to cause the hydrolysis and polycondensation of the alkoxysilane, thereby preparing composites comprising nanometer-sized, mesoporous silica particles, the cationic surfactant and the nonionic surfactant, (2) applying a solution containing the composites to the substrate or the dense layer, (3) drying the solution to remove the solvent, and (4) baking the resultant coating at a temperature of 120-250° C. in an oxygen-containing gas atmosphere to remove the cationic surfactant and the nonionic surfactant.

The second method of the present invention for forming a mesoporous silica layer composed of nanometer-sized, mesoporous silica particles on an optical substrate or a dense layer formed thereon, comprises the steps of (1) aging a solution comprising alkoxysilane, a catalyst, a cationic surfactant, a nonionic surfactant and a solvent to cause the hydrolysis and polycondensation of the alkoxysilane, thereby preparing composites comprising nanometer-sized, mesoporous silica particles, the cationic surfactant and the nonionic surfactant, (2) applying a solution containing the composites to the substrate or the dense layer, (3) drying the solution to remove the solvent, and (4) subjecting the resultant coating to a plasma treatment using an oxygen-containing gas to remove the cationic surfactant and the nonionic surfactant. The plasma treatment step (4) is preferably caused by plasma discharge in an atmosphere of the oxygen-containing gas. The power density of the plasma discharge per a unit area is preferably 0.1-3 W/cm².

In the first and second methods, the composites-preparing step (1) is carried out preferably by the steps of (i) aging a solution comprising the alkoxysilane, an acid catalyst, the cationic surfactant, the nonionic surfactant and the solvent to cause the hydrolysis and polycondensation of the alkoxysilane, and (ii) adding a base catalyst to an acidic sol containing the resultant silicate to prepare composites of nanometer-sized, mesoporous silica particles coated with the nonionic surfactant and containing the cationic surfactant in pores. The coating formed by the drying step (3) preferably has a thickness of 500 nm or less.

It is preferable that the cationic surfactant is n-hexadecyl trimethyl ammonium chloride, and that the nonionic surfactant is a block copolymer represented by the formula of RO(C₂H₄O)ₐ—(C₃H₆O)_{b}—(C₂H₄O)_{c}R, wherein a and c are respectively 10-120, b is 30-80, and R is a hydrogen atom or an alkyl group having 1-12 carbon atoms. A molar ratio of the cationic surfactant to the nonionic surfactant is preferably more than 8 and 60 or less.

The mesoporous silica layer of the present invention formed by the first and second methods is composed of nanometer-sized, mesoporous silica particles having an average diameter of 200 nm or less, a refractive index of 1.09-1.25 and porosity of 45-80%. The nanometer-sized, mesoporous silica particles preferably have a hexagonal structure. In a pore diameter distribution curve obtained by a nitrogen adsorption method, a peak corresponding to the diameters of pores in particles is preferably in a range of 2-10 nm, and a peak corresponding to the diameters of pores among particles is preferably in a range of 5-200 nm.

The anti-reflection coating of the present invention comprises the above mesoporous silica layer formed on an optical substrate or a dense layer formed thereon.

The optical member of the present invention comprises an anti-reflection coating comprising the above mesoporous silica layer formed on an optical substrate or a dense layer formed thereon.

### BRIEF DESCRIPTION OF THE DRAWINGS

FIG. 1 is a cross-sectional view showing one example of the mesoporous silica layers of the present invention formed on an optical substrate.

FIG. 2 is a perspective view showing one example of mesoporous silica particles constituting the mesoporous silica layer shown in FIG. 1.

FIG. 3 is a graph showing a typical pore diameter distribution curve.

FIG. 4 is a graph showing the thermal weight changes of the composites of nanometer-sized, mesoporous silica particles and surfactants in Example 1 and Comparative Example 1.

FIG. 5 is a graph showing the absorbance of a substrate in Comparative Example 10.

FIG. 6 is a graph showing the absorbance of a substrate in Comparative Example 11.

FIG. 7 is a graph showing the absorbance of a substrate in Comparative Example 12.

FIG. 8 is a graph showing the absorbance of a substrate in Comparative Example 13.

### DESCRIPTION OF THE PREFERRED EMBODIMENTS

[1] Starting Materials

(1) Alkoxysilane

The alkoxysilane may be a monomer or an oligomer. The alkoxysilane monomer preferably has 3 or more alkoxy groups. The use of the alkoxysilane having 3 or more alkoxy groups as a starting material provides a mesoporous silica layer with excellent uniformity. Specific examples of the alkoxysilane monomers include methyltrimethoxysilane, methyltriethoxysilane, phenyltriethoxysilane, tetramethoxysilane, tetraethoxysilane, tetrapropoxysilane, tetrabutoxysilane, diethoxydimethoxysilane, dimethyldimethoxysilane, dimethyldiethoxysilane, etc. The alkoxysilane oligomers are preferably polycondensates of these monomers. The alkoxysilane oligomers can be obtained by the hydrolysis and polycondensation of the alkoxysilane monomers. Specific examples of the alkoxysilane oligomers include silsesquioxane represented by the general formula: RSiO_{1.5}, wherein R represents an organic functional group.

(2) Surfactants

(a) Cationic Surfactants

Specific examples of the cationic surfactants include alkyl trimethyl ammonium halides, alkyl triethyl ammonium halides, dialkyl dimethyl ammonium halides, alkyl methyl ammonium halides, alkoxy trimethyl ammonium halides, etc. The alkyl trimethyl ammonium halides include lauryl trimethyl ammonium chloride, cetyl trimethyl ammonium chloride, cetyl trimethyl ammonium bromide, stearyl trimethyl ammonium chloride, benzyl trimethyl ammonium chloride, behenyl trimethyl ammonium chloride, etc. The alkyl trimethyl ammonium halides include n-hexadecyl trimethyl ammonium chloride, etc. The dialkyl dimethyl ammonium halides include distearyl dimethyl ammonium chloride, stearyl dimethylbenzyl ammonium chloride, etc. The alkyl methyl ammonium halides include dodecyl methyl ammonium chloride, cetyl methyl ammonium chloride, stearyl methyl ammonium chloride, benzyl methyl ammonium chloride, etc. The alkoxy trimethyl ammonium halides include octadesiloxypropyl trimethyl ammonium chloride, etc.

(b) Nonionic Surfactants

The nonionic surfactants include block copolymers of ethylene oxide and propylene oxide, polyoxyethylene alkylethers, etc. The block copolymers of ethylene oxide and propylene oxide include, for instance, those represented by the formula of RO(C₂H₄O)ₐ—(C₃H₆O)_{b}—(C₂H₄O)_{c}R, wherein a and c are respectively 10-120, b is 30-80, and R is a hydrogen atom or an alkyl group having 1-12 carbon atoms. The block copolymers are commercially available as, for instance, Pluronic (registered trademark of BASF). The polyoxyethylene alkyl ethers include polyoxyethylene lauryl ether, polyoxyethylene cetyl ether, polyoxyethylene stearyl ether, etc.

(3) Catalysts

(a) Acid Catalysts

Specific examples of the acid catalysts include inorganic acids such as hydrochloric acid, sulfuric acid, nitric acid, etc. and organic acids such as formic acid, acetic acid, etc.

(b) Base Catalysts

Specific examples of the base catalysts include ammonia, amines, NaOH and KOH. The preferred examples of the amines include alcohol amines and alkyl amines (methylamine, dimethylamine, trimethylamine, n-propylamine, n-butylamine, etc.).

(4) Solvents

The solvent is preferably pure water.

[2] Optical Substrate and Dense Layer

Specific examples of materials for the optical substrate, which may be called substrate simply, include optical glass such as BK7, BAH27, LASF01, LASF08, LASF016, LaFK55, LAK14, SF5, quartz, etc., and plastics such as acrylic resins, polycarbonates, cyclic polyolefins, amorphous polyolefins, etc. These substrates have refractive indices of about 1.5-1.9. The substrate may be in a shape of a flat plate, a lens, a prism, a light guide, a film, a diff action grating, etc.

The substrate may have a dense layer. The dense layer is made of inorganic materials such as metal oxides. Specific examples of the inorganic materials include magnesium fluoride, calcium fluoride, aluminum fluoride, lithium fluoride, sodium fluoride, cerium fluoride, cryolite (Na₃AlF₆), chiolite (Na₅Al₃F₁₄), SiO₂, Al₂O₃, Ta₂O₅, TiO₂, Nb₂O₅, ZrO₂, HfO₂, CeO₂, SnO₂, In₂O₃, ZnO, Y₂O₃, Pr₆O₁₁, and mixtures thereof The dense layer may be single or multilayer. When the dense layer is a single layer, the refractive index decreases preferably in the order from the substrate to the dense layer to the mesoporous silica coating. When the dense layer is multilayer, the substrate, the dense multilayer and the mesoporous silica layer are designed preferably such that lights reflected at their interfaces and those incident to them are canceling each other by interference. The dense layer can be formed by a physical vapor deposition method, a chemical vapor deposition method, etc.

[3] Formation of Mesoporous Silica Coating

(1) First Method

The first method for forming a mesoporous silica layer comprises the steps of (a) aging a solution comprising alkoxysilane, a catalyst, a cationic surfactant, a nonionic surfactant and a solvent to cause the hydrolysis and polycondensation of the alkoxysilane, (b) applying a solution containing the resultant nanometer-sized, mesoporous silica particles to an optical substrate or a dense layer formed thereon, (c) drying the resultant coating to remove the solvent, and (d) baking the coating at a temperature of 120-250° C. in an oxygen-containing gas atmosphere to remove the cationic surfactant and the nonionic surfactant.

(a) Hydrolysis and Polycondensation

The hydrolysis and polycondensation of alkoxysilane is preferably conducted by (i) aging a solution comprising alkoxysilane, an acid catalyst, a cationic surfactant, a nonionic surfactant and a solvent, and (ii) adding a base catalyst to an acidic sol containing the resultant silicate.

(i) Hydrolysis and polycondensation under acidic conditions

The hydrolysis and polycondensation is conducted by adding the acid catalyst to pure water to prepare an acidic solution, to which the cationic surfactant and the nonionic surfactant are added to prepare a solution, to which the alkoxysilane is added. The acidic solution preferably has pH of about 2. Because silanol groups in the alkoxysilane have an isoelectric point of about pH 2, silanol groups are stable in the acidic solution near pH 2. A solvent/alkoxysilane molar ratio is preferably 30-300. When this molar ratio is less than 30, the degree of polymerization of alkoxysilane is too high. When it is more than 300, the degree of polymerization of alkoxysilane is too low.

A cationic surfactant/solvent molar ratio is preferably 1×10⁻⁴ to 3×10⁻³, to provide nanometer-sized, mesoporous silica particles with excellent regularity of meso-pores. This molar ratio is more preferably 1.5×10⁻⁴ to 2×10⁻³.

A cationic surfactant/alkoxysilane molar ratio is preferably 1×10⁻¹ to 3×10⁻¹. When this molar ratio is less than 1×10⁻¹, the formation of the meso-structure of nanometer-sized, mesoporous silica particles is insufficient.

When it is more than 3×10⁻¹, the nanometer-sized, mesoporous silica particles have too large diameters. This molar ratio is more preferably 1.5×10⁻¹ to 2.5×10⁻¹.

A nonionic surfactant/alkoxysilane molar ratio is 3.5×10⁻³ or more and less than 2.5×10⁻². When this molar ratio is less than 3.5×10⁻³, the mesoporous silica layer has too large a refractive index. When it is 2.5×10⁻² or more, the mesoporous silica layer has too small a refractive index.

A cationic surfactant/nonionic surfactant molar ratio is preferably more than 8 and 60 or less to provide nanometer-sized, mesoporous silica particles with excellent regularity of meso-pores. This molar ratio is more preferably 10-50.

The alkoxysilane-containing solution is aged for about 1-24 hours. Specifically, the solution is left to stand or slowly stirred at 20-25° C. The aging turns the alkoxysilane by hydrolysis and polycondensation to an acidic sol containing silicate oligomers.

(ii) Hydrolysis and Polycondensation Under Basic Conditions

A base catalyst is added to the acidic sol to turn the solution basic, to further conduct the hydrolysis and polycondensation. The pH of the solution is preferably adjacent to 9-12.

A silicate skeleton is formed around a cationic surfactant micelle by the addition of the base catalyst, and grows with regular hexagonal arrangement, thereby forming composite particles of silica and the cationic surfactant. As the composite particles grow, effective charge on their surfaces decreases, so that the nonionic surfactant is adsorbed to their surfaces, resulting in a solution (sol) of nano-sized, mesoporous silica particles covered with the nonionic surfactant and containing the cationic surfactant in pores, which may be called “composites of nanometer-sized, mesoporous silica particles and surfactants.” See, for instance, Hiroaki Imai, “Chemical Industries,” September, 2005, Vol. 56, No. 9, pp. 688-693, issued by Kagaku Kogyo-Sha. In the process of forming the nanometer-sized, mesoporous silica composite particles, their growth is suppressed by the adsorption of the nonionic surfactant. Accordingly, the nanometer-sized, mesoporous silica composite particles obtained by using the above two types of surfactants (a cationic surfactant and a nonionic surfactant) have an average diameter of 200 nm or less and excellent regularity of meso-pores.

(b) Coating

A solution (sol) containing composites of nanometer-sized, mesoporous silica particles and surfactants is applied to a substrate or a dense layer formed thereon. A sol-coating method may be a spin-coating method, a dip-coating method, a spray-coating method, a flow-coating method, a bar-coating method, a reverse-coating method, a flexographic printing method, a printing method, or their combination. The thickness of the resultant porous coating can be controlled, for instance, by the adjustment of a substrate-rotating speed in the spin-coating method, by the adjustment of a pulling-up speed in the dipping method, or by the adjustment of a concentration in the coating solution. The substrate-rotating speed in the spin-coating method is preferably about 500 rpm to about 10,000 rpm.

To provide the sol with proper concentration and fluidity, a basic aqueous solution having substantially the same pH as that of the sol may be added as a dispersing medium before coating. The percentage of the composites of nanometer-sized, mesoporous silica particles and surfactants in the coating solution is preferably 10-50% by mass to obtain a uniform porous layer.

(c) Drying

The solvent and an alcohol generated by the polycondensation of the alkoxysilane are removed by drying the coated sol. The drying conditions of the coating are not restricted, but may be properly selected depending on the heat resistance of the substrate, etc. The coating may be spontaneously dried, or heat-treated at a temperature of 50-100° C. for 15 minutes to 1 hour for acceleration. The dry thickness of the coating is preferably 500 nm or less.

(d) Baking

A solvent-removed coating is baked at a temperature of 120-250° C. in an oxygen-containing gas atmosphere to remove the cationic surfactant and the nonionic surfactant, thereby forming a mesoporous silica layer. The cationic surfactant and the nonionic surfactant can be decomposed by oxidation by heating at 120-250° C. in an oxygen-containing gas atmosphere. The oxygen-containing gas may be oxygen, air, a mixed gas comprising 10-50% by volume of oxygen and an inert gas other than nitrogen, etc., but air is preferable. If necessary, an oxygen-containing gas at the above temperature may be blown to the solvent-removed coating. When the baking temperature is lower than 120° C., both surfactants are not fully removed. When it is higher than 250° C., substrates of optical glass or plastics having low glass transition temperatures are deformed. The baking temperature is preferably 140-250° C. The baking time may be determined depending on the temperature, but it is preferably 1-100 hours, more preferably 2-80 hours.

(2) Second Method

The second method for forming a mesoporous silica layer is the same as the first method, except that a plasma treatment using an oxygen-containing gas is conducted in place of baking to remove the cationic surfactant and nonionic surfactant. Accordingly, only differences will be explained below.

The plasma-treating method is preferably (a) a direct method in which a dried coating put in an oxygen-containing gas atmosphere receives plasma discharge, or (b) an indirect method in which a plasma gas obtained by plasma discharge in an oxygen-containing gas is blown to the dried coating. The oxygen-containing gas may be the same as described above. In either direct or indirect method, the plasma treatment may be conducted at atmospheric or reduced pressure.

(a) Direct Method

In the direct method, a parallel-flat-plate-type plasma discharge apparatus having opposing upper and lower electrodes is preferably used. A substrate having the dried coating is placed on the lower electrode for plasma discharge. Power density applied to the dried coating is preferably 0.1-3 W/cm², more preferably 0.1-2 W/cm². Power frequency is preferably 1-30 MHz. Plasma-discharging time is preferably 60-1,000 seconds. In the case of plasma discharge at reduced pressure, it is preferably conducted at reduced pressure of 1-40 Pa, particularly 1-30 Pa, while supplying an oxygen-containing gas. The substrate temperature during discharge is preferably 20-200° C.

(b) Indirect Method

In the indirect method, an oxygen-containing gas is preferably supplied from a high-pressure reservoir to a plasma gas generator, from which a plasma gas is blown to the dried coating through a nozzle, a blower, etc.

[4] Mesoporous Silica Layer and its Applications

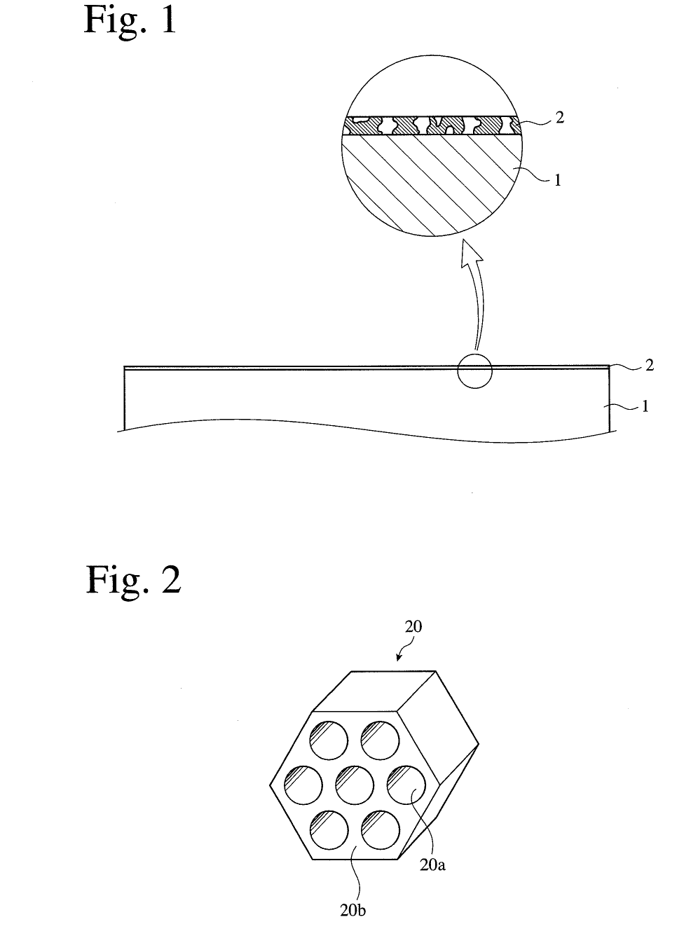

FIG. 1 shows a mesoporous silica layer 2 formed on a substrate 1. The mesoporous silica layer 2 is composed of nanometer-sized, mesoporous silica particles. FIG. 2 shows one example of the nanometer-sized, mesoporous silica particles. This particle 20 has a porous structure constituted by a silica skeleton 20b having meso-pores 20a arranged hexagonally and regularly. However, the nanometer-sized, mesoporous silica particle 20 is not restricted to have a hexagonal structure, but may have a cubic or lamella structure. Although the mesoporous silica layer 2 may be composed of one or more types of these three structures, it is preferably composed of hexagonal particles 20.

The average diameter of the nanometer-sized, mesoporous silica particles 20 is preferably 200 nm or less, more preferably 20-50 nm. When this average diameter is more than 200 nm, it is difficult to control the thickness of the mesoporous silica layer 2, resulting in a mesoporous silica layer with low design flexibility as well as low anti-reflection performance and cracking resistance. The average diameter of the nanometer-sized, mesoporous silica particles 20 is measured by a dynamic light-scattering method. The refractive index of the mesoporous silica layer 2 depends on its porosity: the larger the porosity, the smaller the refractive index. The porosity of the mesoporous silica layer 2 is preferably 45-80%. The mesoporous silica layer 2 having porosity in this range has a refractive index of 1.09-1.25.

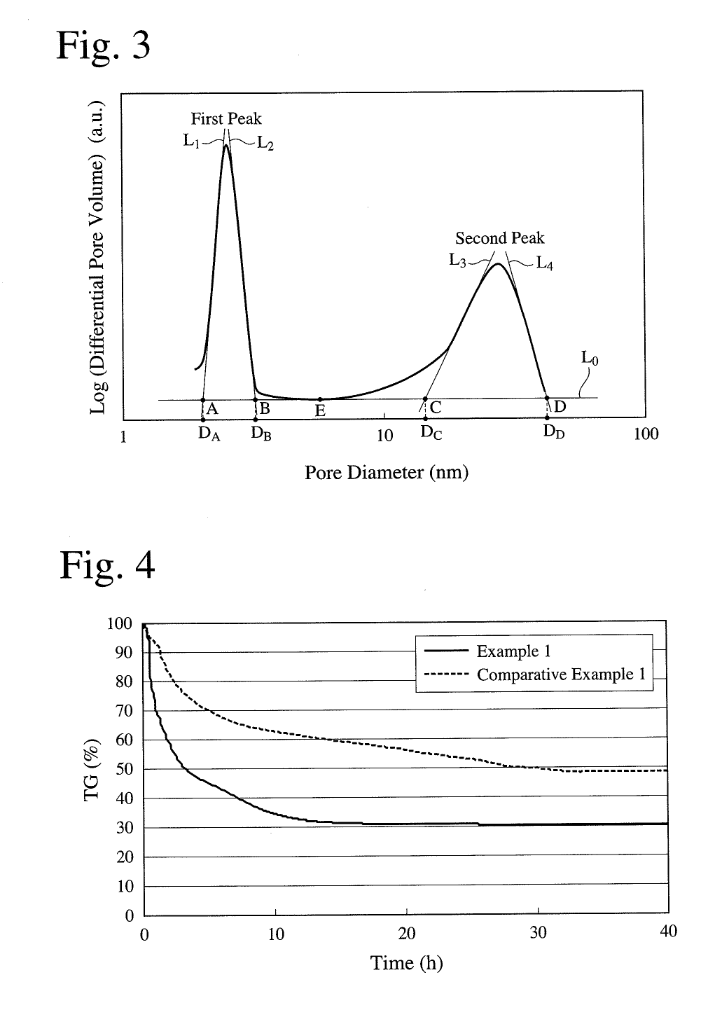

As shown in FIG. 3, a pore diameter distribution curve of the mesoporous silica layer 2 obtained by a nitrogen adsorption method preferably has two peaks. Specifically, the pore diameter distribution curve is determined from the isothermal nitrogen desorption curve of the mesoporous silica layer 2 by analysis by a BJH method. In FIG. 3, the axis of abscissas represents a pore diameter, and the axis of ordinates represents log (differential pore volume). The BJH method is described, for instance, in “Method for Determining Distribution of Meso-Pores,” E. P. Barrett, L. G. Joyner, and P. P. Halenda, J. Am. Chem. Soc., 73, 373 (1951). Log (differential pore volume) is expressed by dV/d (log D), in which dV represents small pore volume increment, and d (log D) represents the small increment of log (pore diameter D).

A first peak on the smaller pore diameter side is attributed to the diameters of pores in particles, and a second peak on the larger pore diameter side is attributed to the diameters of pores among particles. The mesoporous silica layer 2 preferably has a pore diameter distribution having the first peak (the diameters of pores in particles) in a range of 2-10 nm, and the second peak (the diameters of pores among particles) in a range of 5-200 nm.

A ratio of the total volume V₁ of pores in particles to the total volume V₂ of pores among particles is preferably 1/15 to 1/1. The total volumes V₁ and V₂ are determined by the following method. In FIG. 3, a straight line passing a point E of the minimum value in the ordinate between the first and second peaks and in parallel with the axis of abscissas is defined as a baseline L₀, the maximum inclination lines (tangent lines at the maximum inclination points) of the first peak are defined as L₁ and L₂, and the maximum inclination lines (tangent lines at the maximum inclination points) of the second peak are defined as L₃ and L₄. Values in the abscissas at intersections A to D between the maximum inclination lines L₁ to L₄ and the baseline L₀ are defined as D_{A} to D_{D}. By the BJH method, the total volume V₁ of pores in a range from D_{A} to D_{B}, and the total volume V₂ of pores in a range from D_{C} to D_{D} are calculated.

The mesoporous silica layer 2 has as small a refractive index as 1.09-1.25, excellent anti-reflection characteristics to light rays in a wide wavelength range, and excellent uniformity. The formation of the mesoporous silica layer of the present invention having such excellent anti-reflection characteristics on a lens remarkably reduces differences in the amount and color of transmitting light rays between the center and peripheral regions of the lens, ghost due to light reflection at lens peripheries, etc. Optical members with such excellent characteristics can provide remarkably improved image quality when used in cameras, endoscopes, binoculars, projectors, etc. Further, the mesoporous silica layer of the present invention enjoys low production cost and high yield. The mesoporous silica layer 2 preferably has a physical thickness of 15-500 nm.

The present invention will be explained in further detail by Examples below without intention of restricting the present invention thereto.

### Example 1

40 g of hydrochloric acid (0.01 N) having pH of 2 was mixed with 1.21 g (0.088 mol/L) of n-hexadecyltrimethylammonium chloride (available from Kanto Chemical Co. Ltd.), and 2.41 g (0.0043 mol/L) of a block copolymer of HO(C₂H₄O)₁₀₆—(C₃H₆O)₇₀—(C₂H₄O)₁₀₆H (“Pluronic F127” available from Sigma-Aldrich), stirred at 25° C. for 1 hour, mixed with 4.00 g (0.45 mol/L) of tetraethoxysilane (available from Kanto Chemical Co. Ltd.), stirred at 25° C. for 1 hour, mixed with 3.94 g (1.51 mol/L) of 28-%-by-mass ammonia water to adjust the pH to 10.6, and then stirred at 25° C. for 0.5 hours. The resultant composite solution of nanometer-sized, mesoporous silica particles and surfactants was spin-coated onto a flat BK7 glass plate of 30 mm in diameter and 1.5 mm in thickness having a refractive index of 1.518, dried at 80° C. for 0.5 hours, and then baked at 250° C. for 3 hours in air.

### Example 2

A mesoporous silica layer was formed in the same manner as in Example 1 except for conducting baking at 200° C. for 3 hours.

### Example 3

A mesoporous silica layer was formed in the same manner as in

Example 1 except for conducting baking at 200° C. for 12 hours.

### Example 4

A mesoporous silica layer was formed in the same manner as in Example 1 except for conducting baking at 200° C. for 24 hours.

### Example 5

A mesoporous silica layer was formed in the same manner as in Example 1 except for conducting baking at 200° C. for 48 hours.

### Example 6

A mesoporous silica layer was formed in the same manner as in Example 1 except for conducting baking 150° C. for 48 hours.

### Example 7

A mesoporous silica layer was formed in the same manner as in Example 1 except for conducting baking 150° C. for 72 hours.

### Example 8

A mesoporous silica layer was formed in the same manner as in Example 1 except for conducting, in place of baking, plasma discharge at a power density of 0.7 W/cm² and a power frequency of 13.56 MHz for 2 minutes, while supplying 80 mL/min of an oxygen gas at reduced pressure of 15 Pa, using a plasma cleaner (PDC210 available from Yamato Scientific Co., Ltd.). The substrate temperature during discharge was 25° C.

### Example 9

A mesoporous silica layer was formed in the same manner as in Example 8 except for changing the plasma discharge time to 5 minutes.

### Example 10

A mesoporous silica layer was formed in the same manner as in Example 8 except for changing the plasma discharge time to 10 minutes.

### Example 11

A mesoporous silica layer was formed in the same manner as in Example 8 except for changing the plasma discharge time to 15 minutes.

### Comparative Example 1

A mesoporous silica layer was formed in the same manner as in Example 1 except for preparing composites of nanometer-sized, mesoporous silica particles and surfactants without adding the block copolymer of HO(C₂H₄O)₁₀₆—(C₃H₆O)₇₀—(C₂H₄O)₁₀₆H.

### Comparative Example 2

A mesoporous silica layer was formed in the same manner as in Example 1 except for conducting baking at 500° C. for 3 hours.

### Comparative Example 3

A mesoporous silica layer was formed in the same manner as in Example 1 except for conducting baking at 550° C. for 3 hours.

### Comparative Example 4

A mesoporous silica layer was formed in the same manner as in Example 1 except for conducting, in place of baking, ultraviolet irradiation at 1.6 W/cm² for 1 minute, using a UV lamp apparatus (F300S, with light source of a D-type electrodeless lamp valve, available from Fusion UV Systems Japan K. K.).

### Comparative Example 5

A mesoporous silica layer was formed in the same manner as in Comparative Example 4 except for changing the ultraviolet irradiation time to 2 minutes.

### Comparative Example 6

A mesoporous silica layer was formed in the same manner as in Comparative Example 4 except for changing the ultraviolet irradiation time to 3 minutes.

### Comparative Example 7

A mesoporous silica layer was formed in the same manner as in Comparative Example 6 except for using a flat LaFK55 glass plate of 30 mm in diameter and 1.5 mm in thickness having refractive index of 1.697 as an optical substrate.

### Comparative Example 8

A mesoporous silica layer was formed in the same manner as in Comparative Example 6 except for using a flat BAH27 glass plate of 30 mm in diameter and 2.5 mm in thickness having a refractive index of 1.706 as an optical substrate.

### Comparative Example 9

A mesoporous silica layer was formed in the same manner as in Comparative Example 6 except for using a flat LaSF08 glass plate of 30 mm in diameter and 1.0 mm in thickness having a refractive index of 1.888 as an optical substrate.

The characteristics of anti-reflection coatings obtained in Examples 1-11 and Comparative Examples 1-9 are shown in Table 1. The measurement of refractive index and physical thickness was conducted using a lens reflectance meter (“USPM-RU” available from Olympus Optical Co., Ltd.), and the measurement of haze was conducted at a wavelength of 550 nm using a haze transmittance meter (“HM-150” available from Murakami Color Research Laboratory).

TABLE 1

Surfactant-Removing Method

| No. | Substrate | Treatment | Time | |
|---|---|---|---|---|
| Example 1 | BK7 | Baking at 200° C. | 3 | hours |
| Example 2 | BK7 | Baking at 200° C. | 3 | hours |
| Example 3 | BK7 | Baking at 200° C. | 12 | hours |
| Example 4 | BK7 | Baking at 200° C. | 24 | hours |
| Example 5 | BK7 | Baking at 200° C. | 48 | hours |
| Example 6 | BK7 | Baking at 150° C. | 48 | hours |
| Example 7 | BK7 | Baking at 150° C. | 72 | hours |
| Example 8 | BK7 | Plasma Discharge | 2 | minutes |
| Example 9 | BK7 | Plasma Discharge | 5 | minutes |
| Example 10 | BK7 | Plasma Discharge | 10 | minutes |
| Example 11 | BK7 | Plasma Discharge | 15 | minutes |
| Comparative | BK7 | Baking at 250° C. | 3 | hours |
| Example 1⁽¹⁾ | | | | |
| Comparative | BK7 | Baking at 500° C. | 3 | hours |
| Example 2 | | | | |
| Comparative | BK7 | Baking at 550° C. | 3 | hours |
| Example 3 | | | | |
| Comparative | BK7 | UV Irradiation | 1 | minute |
| Example 4 | | | | |
| Comparative | BK7 | UV Irradiation | 2 | minutes |
| Example 5 | | | | |
| Comparative | BK7 | UV Irradiation | 3 | minutes |
| Example 6 | | | | |
| Comparative | LaFK55 | UV Irradiation | 3 | minutes |
| Example 7 | | | | |
| Comparative | BAH27 | UV Irradiation | 3 | minutes |
| Example 8 | | | | |
| Comparative | LaSF08 | UV Irradiation | 3 | minutes |
| Example 9 | | | | |

| | Characteristics of mesoporous silica layer | | | | |
|---|---|---|---|---|---|
| | Refractive | | Physical | Optical | |
| | Index | Porosity | Thickness | Thickness | Haze |
| No. | (%) | (%) | (nm) | (nm) | (%) |
| Example 1 | 1.113 | 73.6 | 254 | 283 | 0.2 |
| Example 2 | 1.161 | 62.7 | 242 | 281 | 0.3 |
| Example 3 | 1.126 | 70.6 | 231 | 260 | 0.2 |
| Example 4 | 1.138 | 67.9 | 241 | 274 | 0.2 |
| Example 5 | 1.139 | 67.7 | 241 | 275 | 0.2 |
| Example 6 | 1.188 | 56.8 | 243 | 289 | 0.3 |
| Example 7 | 1.163 | 62.3 | 236 | 274 | 0.2 |
| Example 8 | 1.188 | 56.8 | 223 | 265 | 0.3 |
| Example 9 | 1.157 | 63.6 | 201 | 233 | 0.3 |
| Example 10 | 1.150 | 65.2 | 179 | 206 | 0.2 |
| Example 11 | 1.150 | 65.2 | 176 | 202 | 0.2 |
| Comparative | — | — | — | — | 51.8 |
| Example 1⁽¹⁾ | | | | | |
| Comparative | 1.125 | 70.9 | 179 | 201 | 0.2 |
| Example 2 | | | | | |
| Comparative | 1.144 | 66.5 | 142 | 163 | 0.2 |
| Example 3 | | | | | |
| Comparative | 1.313 | 30.2 | 307 | 403 | 0.4 |
| Example 4 | | | | | |
| Comparative | 1.119 | 72.2 | 284 | 318 | 0.2 |
| Example 5 | | | | | |
| Comparative | 1.098 | 77.0 | 294 | 323 | 0.2 |
| Example 6 | | | | | |
| Comparative | 1.101 | 76.3 | 255 | 281 | 0.2 |
| Example 7 | | | | | |
| Comparative | 1.111 | 74.0 | 252 | 280 | 0.3 |
| Example 8 | | | | | |
| Comparative | 1.100 | 76.6 | 271 | 298 | 0.3 |
| Example 9 | | | | | |

Note:
⁽¹⁾The nonionic surfactant was not used.

Thermal Weight Analysis

With respect to the dried composites of nanometer-sized, mesoporous silica particles and surfactants in Example 1 and Comparative Example 1, their weight changes were measured at 200° C. in air using a thermal analyzer (“TG/DTA-320” available from Seiko Instruments Inc.). The total weight of the mesoporous silica and the surfactants was assumed as 100% by mass. The composites of Example 1 had a composition comprising 24.1% by mass of mesoporous silica and 75.9% by mass of surfactants, and the composites of Comparative Example 1 had a composition comprising 48.7% by mass of mesoporous silica and 51.3% by mass of surfactants. The results are shown in FIG. 4.

As is clear from FIG. 4, the time necessary for removing substantially all surfactants at 200° C. was 15 hours in Example 1, and 30 hours or more in Comparative Example 1. The weight of the composites became substantially constant at 30% by mass, larger than the calculated value of 24.1% by mass in Example 1, presumably because part of the surfactants were removed by drying at 80° C. It was found that because the use of both cationic surfactant and nonionic surfactant made it possible to control the mesoporous silica particles on a nanometer size, the surfactants were efficiently removed from the composites of nanometer-sized, mesoporous silica particles and surfactants by baking.

### Comparative Example 10

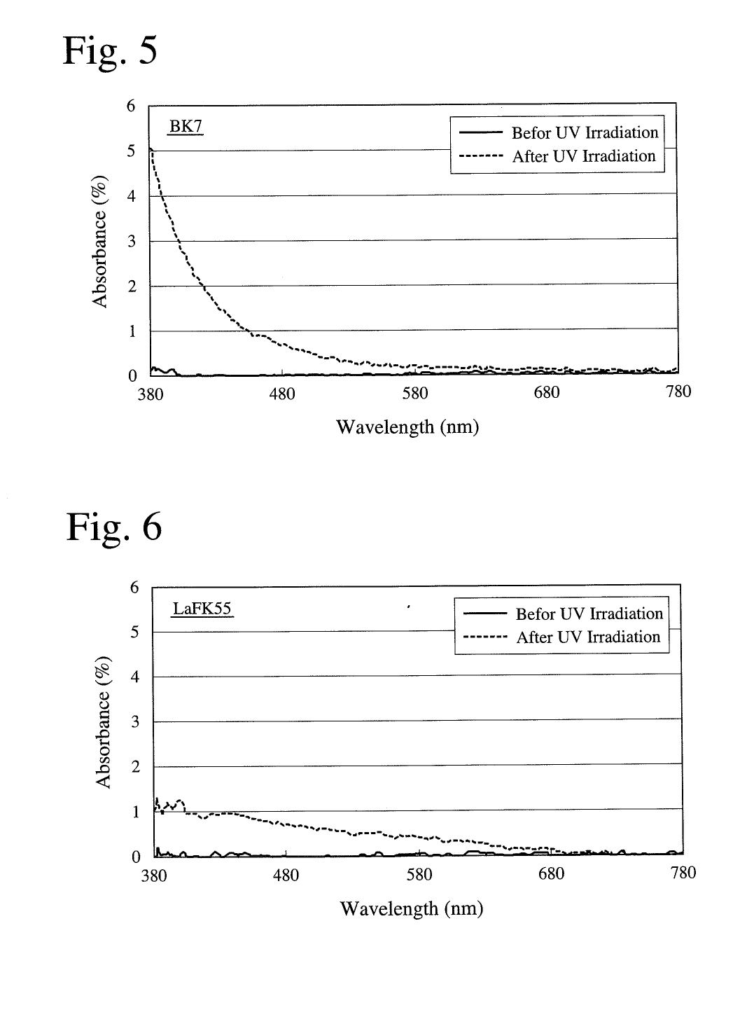

A flat BK7 glass plate was subjected to ultraviolet irradiation at 1.6 W/cm² for 3 minutes using the above UV lamp, to measure its reflectance (%), transmittance (%) and haze (%) in a wavelength of 380-780 nm before and after ultraviolet irradiation, and the absorbance before and after ultraviolet irradiation was calculated by the formula of absorbance (%)=100−[reflectance (%)+transmittance (%)+haze (%)]. The results are shown in FIG. 5.

### Comparative Example 11

The absorbance of a flat LaFK55 glass plate before and after ultraviolet irradiation was obtained in the same manner as in Comparative Example 10. The results are shown in FIG. 6.

### Comparative Example 12

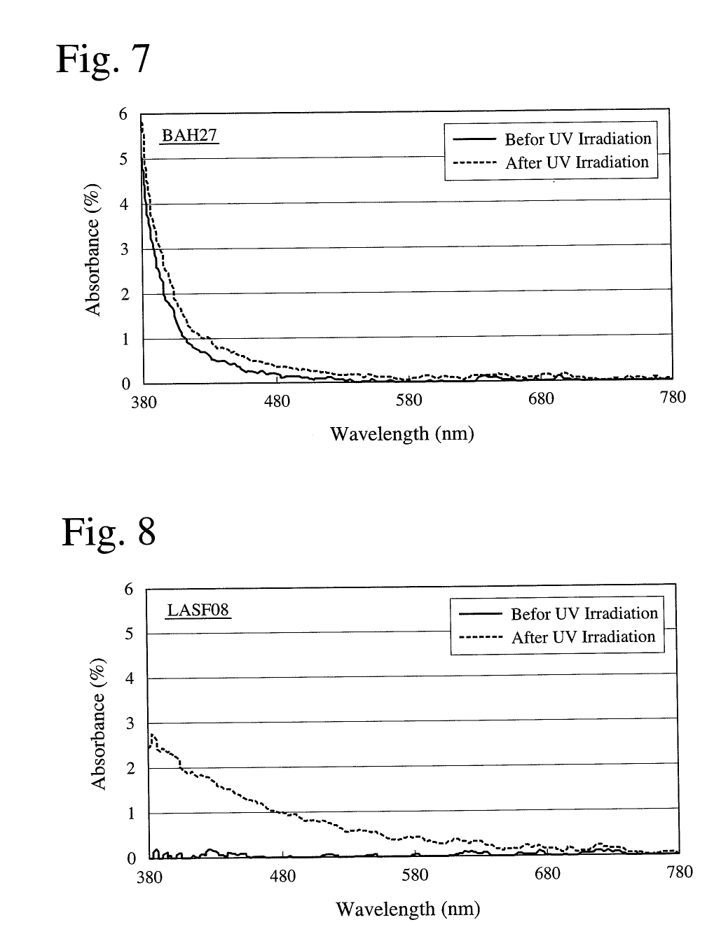

The absorbance of a flat BAH27 glass plate before and after ultraviolet irradiation was obtained in the same manner as in Comparative Example 10. The results are shown in FIG. 7.

### Comparative Example 13

The absorbance of a flat LaSF08 glass plate before and after ultraviolet irradiation was obtained in the same manner as in Comparative Example 10. The results are shown in FIG. 8.

As is clear from Table 1, any mesoporous silica layers of Examples 1-11 had low refractive indices and high transparency. On the other hand, the coating of Comparative Example 1 formed without using a nonionic surfactant had low transparency presumably because mesoporous silica particles could not be controlled on a nanometer size. The mesoporous silica layers of Comparative Examples 2-9 also had low refractive indices and high transparency. However, the methods of Comparative Examples 2 and 3 conducting baking at as high temperatures as 500° C. and 550° C., respectively, can be used only for glass materials having glass transition temperatures higher than the baking temperatures. As is clear from FIGS. 5-8, ultraviolet irradiation increases the absorbance of the substrate. Accordingly, the ultraviolet irradiation methods in Comparative Examples 4-9 apparently increase the absorbance of the substrate.

### Effect of the Invention

Because composites comprising nanometer-sized, mesoporous silica particles and surfactants, which are obtained by the hydrolysis and polycondensation of alkoxysilane in the presence of a cationic surfactant and a nonionic surfactant, are dried, and then baked at a temperature of 120-250° C. or plasma-treated in an oxygen-containing gas atmosphere in the method of the present invention, a mesoporous silica layer can be formed while removing surfactants at relatively low temperatures. Because the mesoporous silica layer obtained by the method of the present invention has a low refractive index, it is useful for anti-reflection coatings. An optical member comprising this anti-reflection coating formed on an optical substrate such as a lens or a dense layer formed thereon has remarkably reduced differences in the amount and color of transmitting light rays between its center and peripheral regions, resulting in extremely reduced ghost due to light reflection at lens peripheries, etc.

The present disclosure relates to subject matter contained in Japanese Patent Application No. 2008-308746 filed on Dec. 3, 2008, which is expressly incorporated herein by reference in its entirety.

What is claimed is:

1. A method for forming a mesoporous silica layer composed of nanometer-sized, mesoporous silica particles on an optical substrate or a dense layer formed thereon, comprising the steps of (1) aging a solution comprising alkoxysilane, a catalyst, a cationic surfactant, a nonionic surfactant and a solvent to cause the hydrolysis and polycondensation of said alkoxysilane, thereby preparing composites comprising nanometer-sized, mesoporous silica particles, said cationic surfactant and said nonionic surfactant, (2) applying a solution containing said composites to said substrate or said dense layer, (3) drying said solution to remove said solvent, and (4) baking the resultant coating at a temperature of 120-250° C. in an oxygen-containing gas atmosphere to remove said cationic surfactant and said nonionic surfactant.

2. A method for forming a mesoporous silica layer composed of nanometer-sized, mesoporous silica particles on an optical substrate or a dense layer formed thereon, comprising the steps of (1) aging a solution comprising alkoxysilane, a catalyst, a cationic surfactant, a nonionic surfactant and a solvent to cause the hydrolysis and polycondensation of said alkoxysilane, thereby preparing composites comprising nanometer-sized, mesoporous silica particles, said cationic surfactant and said nonionic surfactant, (2) applying a solution containing said composites to said substrate or said dense layer, (3) drying said solution to remove said solvent, and (4) subjecting the resultant coating to a plasma treatment using an oxygen-containing gas to remove said cationic surfactant and said nonionic surfactant.

3. The method for forming a mesoporous silica layer according to claim 2, wherein said plasma treatment step (4) is caused by plasma discharge in an atmosphere of said oxygen-containing gas.

4. The method for forming a mesoporous silica layer according to claim 3, wherein the power density of said plasma discharge per a unit area is 0.1-3 W/cm².

5. The method for forming a mesoporous silica layer according to claim 1, wherein said composites-preparing step (1) is carried out by the steps of (i) aging a solution comprising said alkoxysilane, an acid catalyst, said cationic surfactant, said nonionic surfactant and said solvent to cause the hydrolysis and polycondensation of said alkoxysilane, and (ii) adding a base catalyst to an acidic sol containing the resultant silicate to prepare composites of nanometer-sized, mesoporous silica particles coated with said nonionic surfactant and containing said cationic surfactant in pores.

6. The method for forming a mesoporous silica layer according to claim 1, wherein the coating formed by said drying step (3) has a thickness of 500 nm or less.

7. The method for forming a mesoporous silica layer according to claim 1, wherein said cationic surfactant is n-hexadecyl trimethyl ammonium chloride, and said nonionic surfactant is a block copolymer represented by the formula of RO(C₂H₄O)ₐ—(C₃H₆O)_{b}—(C₂H₄O)_{c}R, wherein a and c are respectively 10-120, b is 30-80, and R is a hydrogen atom or an alkyl group having 1-12 carbon atoms.

8. The method for forming a mesoporous silica layer according to claim 1, wherein a molar ratio of said cationic surfactant to said nonionic surfactant is more than 8 and 60 or less.

9. A mesoporous silica layer formed by the method recited in claim 1, which is composed of nanometer-sized, mesoporous silica particles having an average diameter of 200 nm or less, a refractive index of 1.09-1.25 and porosity of 45-80%.

10. A mesoporous silica layer formed by the method recited in claim 2, which is composed of nanometer-sized, mesoporous silica particles having an average diameter of 200 nm or less, a refractive index of 1.09-1.25 and porosity of 45-80%.

11. The mesoporous silica layer according to claim 9, wherein said nanometer-sized, mesoporous silica particles have a hexagonal structure.

12. The mesoporous silica layer according to claim 10, wherein said nanometer-sized, mesoporous silica particles have a hexagonal structure.

13. The mesoporous silica layer according to claim 9, which has a peak corresponding to the diameters of pores in particles in a range of 2-10 nm, and a peak corresponding to the diameters of pores among particles in a range of 5-200 nm, in a pore diameter distribution curve obtained by a nitrogen adsorption method.

14. The mesoporous silica layer according to claim 10, which has a peak corresponding to the diameters of pores in particles in a range of 2-10 nm, and a peak corresponding to the diameters of pores among particles in a range of 5-200 nm, in a pore diameter distribution curve obtained by a nitrogen adsorption method.

15. A anti-reflection coating comprising the mesoporous silica layer recited in claim 9, which is formed on an optical substrate or a dense layer formed thereon.

16. A anti-reflection coating comprising the mesoporous silica layer recited in claim 10, which is formed on an optical substrate or a dense layer formed thereon.

17. An optical member comprising an anti-reflection coating formed on an optical substrate or a dense layer formed thereon, said anti-reflection coating comprising the mesoporous silica layer recited in claim 9.

18. An optical member comprising an anti-reflection coating formed on an optical substrate or a dense layer formed thereon, said anti-reflection coating comprising the mesoporous silica layer recited in claim 10.
